(19) United States
(12) Patent Application Publication
(10) Pub. No.: US 2009/0036298 A1
(43) Pub. Date: Feb. 5, 2009

(54) Catalyst Components for the Polymerization of Olefins

(75) Inventors: Giampiero Morini, Padova (IT); Isabella Camurati, Pontergradella Ferrara (IT); Tiziano Dall'Occo, Ferrara (IT); Dario Liguori, Forino (IT); Gianni Vitale, Ferrara (IT)

Correspondence Address: Basell USA Inc., Delaware Corporate Center II, 2 Righter Parkway, Suite #300, Wilmington, DE, 19803, US

(73) Assignee: Basell Poliolefine Italia s.r.l., Milan (IT)

(21) Appl. No.: 11/887,530

(22) PCT Filed: Mar. 15, 2006
(86) PCT No.: PCT/EP2006/060737

§ 371 Date: Sep. 28, 2007

Related U.S. Application Data
(60) Provisional application No. 60/667,253, filed on Apr. 1, 2005.

(30) Foreign Application Priority Data
Mar. 30, 2005 (EP) 05102482.6

(51) Int. Cl. B01J 31/12

(52) U.S. Cl. 502/169; 502/171

(57) ABSTRACT

Catalysts components for the polymerization of ethylene comprising Ti, Mg, halogen, OR^{I} groups, where R^{I} is a C1-C12 hydrocarbon group optionally containing heteroatoms, having specific relationship among OR^{I}/Ti and Mg/Ti molar ratio and characterized by a specific SS-NMR pattern are particularly useful for preparing narrow MWD crystalline ethylene polymers.

The present invention relates to catalysts components for the polymerization of ethylene and its mixtures with olefins CH2=CHR, wherein R is an alkyl, cycloalkyl or aryl radical having 1-12 carbon atoms, comprising Ti, Mg, halogen, OR^{I} groups in a specific ratio, which can be obtained by reacting under specific conditions a titanium compound having at least a Ti—Cl bond with a particular precursor. The catalyst components of the invention are suitably used in (co)polymerization processes of ethylene to prepare, in high yields, especially crystalline polymers having medium-narrow Molecular Weight Distribution (MWD). The MWD is an important characteristic of ethylene polymers in that it affects both the rheological behaviour, and therefore the processability, and the final mechanical properties. In particular, in the case of LLDPE, polymers with narrow MWD are suitable for films and injection molding in that deformation and shrinkage problems in the manufactured article are minimized. The width of the molecular weight distribution for the ethylene polymers is generally expressed as melt flow ratio F/E, which is the ratio between the melt index measured by a load of 21.6 Kg (melt index F) and that measured with a load of 2.16 Kg (melt index E). The measurements of melt index are carried out according to ASTM D-1238 and at 190° C. A catalyst component for preparing ethylene (co)polymers having narrow MWD is described in the European patent application EP-A-553805. The catalyst, comprising Ti, Mg, halogen, OR^{I} groups is characterized by a ratio OR/Ti of at least 0.5, by a porosity (determined with mercury porosimeter) of from 0.35 to 0.7 which furthermore has a specific pore distribution. Said catalyst is obtained by a rather long process which comprises the preparation of a MgCl₂-alcohol adduct having about 3 moles of alcohol which is first thermally dealcoholated up to an intermediate alcohol content and then chemically dealcoholated up to an almost complete extent. The so created porous precursor is then reacted with a titanium alkoxy compound in the presence of a halogenating agent and, optionally, of a reducing agent. The catalyst so obtained is able to produce ethylene (co)polymers with a narrow MWD but the polymerization activities are low. Catalysts that are the product of a somewhat simpler process are described in U.S. Pat. No. 4,220,554. They are obtained by reacting a large excess of TiCl₄ with catalyst precursors of general formula MgClₙ(OR)₂, in the presence of a internal electron donor compound at high temperatures (120° C.). The hydrogen response and the activity of the final catalyst component however, is not satisfactory.

In EP 301 894 a catalyst comprising Ti, Mg, halogen, OR groups (R is an aliphatic, aromatic or cycloaliphatic hydrocarbon radical) in which the Mg/Ti molar ratio is from 0.5 to 50 and the OR/Ti is from 1.5 to 5, is used for the preparation of amorphous ethylene copolymers. All the examples are directed to the production of amorphous copolymers and terpolymers with no indication about the suitability for the production of crystalline ethylene polymers with medium-narrow molecular weight distribution.

It is therefore still felt the need of a catalyst component suited to form a catalyst system showing a good balance of polymerization activity, ability to form ethylene polymers with narrow MWD and good hydrogen response.

The applicant has now found that the above needs are satisfied by catalyst components characterized by certain chemical features and by a specific pattern when analyzed through the solid state NMR (SS-NMR). In particular, said solid catalyst components comprise Ti, Mg, halogen, OR^{I} groups, where R^{I} is a C1-C12 hydrocarbon group optionally containing heteroatoms, having a OR^{I}/Ti molar ratio higher than 1.5 with the proviso that when the OR^{I}/Ti molar ratio is equal to, or lower than, 3 the Mg/Ti molar ratio is less than 4, when the OR^{I}/Ti molar ratio is higher than 4 the Mg/Ti molar ratio is equal to or higher than 4 and when both the Mg/Ti molar ratio and the OR^{I}/Ti molar ratio are in the range from 3 to 4 at least one of the following equations is satisfied:

(Mg/Ti)−(OR^{I}/Ti)≧0.5 (1)

(Mg/Ti)+(OR^{I}/Ti)≧27 (2)

said solid catalyst component being also characterized by the fact it shows in the pattern of the SS-NMR recorded under the conditions set forth below one or more signals (A) having a maximum in the region 60-75 (ppm) and one or more signals (B) having a maximum in the region 78-108 (ppm) such that the ratio I^{A}/I^{B}, in which I^{A} is the integral of the signals having the maximum in the region between 60 and 75 ppm and I^{B} is the integral of the signals having the maximum in the region between 78 and 108 ppm, is higher than 0.8.

Preferably, the ratio I^{A}/I^{B} is higher than 1 and more preferably in the range 1-5.

In a preferred aspect the amount of titanium, with respect to the total weight of said solid catalyst component, is higher than 4% and preferably higher than 5% by wt.

Preferably the OR^{I}/Ti molar ratio is higher than 2.

The applicant has also found that the above catalyst components having the described chemical features can be characterized in an alternative way as the product obtainable by reacting a titanium compound having at least a Ti—Cl bond with a catalyst precursors of formula MgClₙ(OR^{I})₂₋ₙ, where n is from 0.5 to 1.5 and R^{I} has the meaning given above.

In a preferred embodiment of the invention R^{I} is a C1-C8 hydrocarbon group selected from alkyl groups. Among them, particularly preferred are methyl, ethyl, n-propyl, n-butyl, i-butyl, and tert-butyl.

Among the titanium compounds containing at least one Ti-halogen bond, those having the formula Ti(OR^{I})_{p-y}Cl_{y}, wherein R^{I} has the meaning given above, p is the titanium valence and y is a number comprised between 1 and p, are preferred. Particularly preferred are the titanium compounds in which y ranges from 1 to 4 and particularly from 2 to 4, TiCl₄ is especially preferred.

Among the catalyst precursors particularly preferred are those in which R^{I} is selected among a C1-C8 hydrocarbon group, preferably ethyl, and n ranges from 0.6 to 1.4, in particular from 0.7 to 1.3 and especially from 0.8 to 1.2. The said catalyst precursors can be generated by exchange reaction between organometallic compounds of formula ClₘMgR₂₋ₘ, where m is from 0 to 1.5, and R is a hydrocarbon group, with an appropriate OR^{I} group source. The OR^{I} sources are for example R^{I}OH alcohols or, preferably, a silicon compound of formula (R^{I}O)ᵣSiR₄₋ᵣ where r is from 1 to 4 and R^{I} has the meaning given above. In turn, as generally known in the art, organometallic compounds of formula ClₘMgR₂₋ₘ can be obtained by the reaction between Mg metal and an organic chloride RCl, in which R is as defined above, optionally in the presence of suitable promoters. Preferably, the formation of ClₘMgR₂₋ₘ and the further exchange with the OR^{I} source takes place in one single step. The reaction can be carried out in a liquid inert medium such as hydrocarbon that is liquid at room temperature. Usually, upon a substantial amount of exchange with the OR source occurred, the catalyst precursors precipitate and can be easily isolated.

As mentioned above the reaction between titanium compound having at least a Ti—Cl bond and the catalyst precursor should be carried out under different conditions. It is within the ordinary knowledge of the skilled in the art that there are several ways of obtaining the same results.

Given that the titanium compound acts as a halogenating agent with respect to the precursor, it is in principle possible to obtain the desired final ratio either by using a limited molar amount of titanium compound or by keeping conditions such that the halogenation activity is depressed.

According to one preferred embodiment, the catalyst component is obtained by reacting the catalyst precursor with a titanium compound, preferably TiCl₄, used in an amount such that the molar ratio between the titanium compound and the OR^{I} groups of the catalyst precursor and is 4 or less. Preferably said ratio is lower than 3, and more preferably it ranges from 0.1 to 2.5. In this embodiment the reaction temperature is not particularly critical and can range from room temperature up to 150° C. preferably in the range 40-120° C. In view of the limited amount of titanium compound, preferably TiCl₄, it is preferred carrying out the reaction in an inert medium, that is liquid at least at the reaction temperature. Preferred inert medium are liquid aliphatic or aromatic hydrocarbons, optionally chlorinated, and among them those having from 3 to 20 carbon atoms. Especially preferred are propane, n-butane, n-pentane, n-hexane, n-heptane, benzene, toluene and isomers thereof. Mixture of two or more of said hydrocarbons can be used. Provided that the final OR^{I}/Ti molar ratio of higher than 1.5 is maintained, the reaction medium can also comprise chlorinated compounds having a chlorinating ability inferior to that of TiCl₄ such as SiCl₄, SnCl₄ and the like.

Due to the halogenating capability of the titanium compound, upon reaction with the catalyst precursor a certain amount of magnesium chloride may be formed.

The solid catalyst components according to the present invention are converted into catalysts for the polymerization of olefins by reacting them with organoaluminum compounds according to known methods.

In particular, it is an object of the present invention a catalyst for the polymerization of olefins CH₂═CHR, in which R is hydrogen or a hydrocarbyl radical with 1-12 carbon atoms, comprising the product of the reaction between:

(a) a solid catalyst component as described above,
(b) an alkylaluminum compound and, optionally,
(c) an external electron donor compound.

The alkyl-Al compound can be preferably selected from the trialkyl aluminum compounds such as for example trimethylaluminum (TMA), triethylaluminum (TEA), triisobutylaluminum (TIBA)), tri-n-butylaluminum, tri-n-hexylaluminum, tri-n-octylaluminum. Also alkylaluminum halides and in particular alkylaluminum chlorides such as diethylaluminum chloride (DEAC), diisobutylalumunum chloride, Al-sesquichloride and dimethylaluminum chloride (DMAC) can be used. It is also possible to use, and in certain cases preferred, mixtures of trialkylaluminum's with alkylaluminum halides. Among them mixtures between TEAL and DEAC are particularly preferred.

The above mentioned components (a)-(c) can be fed separately into the reactor where, under the polymerization conditions can exploit their activity.

The so formed catalyst system can be used directly in the main polymerization process or alternatively, it can be pre-polymerized beforehand. A pre-polymerization step is usually preferred when the main polymerization process is carried out in the gas phase. The prepolymerization can be carried out with any of the olefins CH₂═CHR, where R is H or a C1-C10 hydrocarbon group. In particular, it is especially preferred to pre-polymerize ethylene or mixtures thereof with one or more α-olefins, said mixtures containing up to 20% in moles of α-olefin, forming amounts of polymer from about 0.1 g per gram of solid component up to about 1000 g per gram of solid catalyst component. The pre-polymerization step can be carried out at temperatures from 0 to 80° C., preferably from 5 to 70° C., in the liquid or gas phase. The pre-polymerization step can be performed in-line as a part of a continuous polymerization process or separately in a batch process. The batch pre-polymerization of the catalyst of the invention with ethylene in order to produce an amount of polymer ranging from 0.5 to 20 g per gram of catalyst component is particularly preferred. Examples of gas-phase processes wherein it is possible to use the catalysts of the invention are described in WO 92/21706, U.S. Pat. No. 5,733,987 and WO 93/03078. These processes comprise a pre-contact step of the catalyst components, a pre-polymerization step and a gas phase polymerization step in one or more reactors in a series of fluidized or mechanically stirred bed. In a particular embodiment, the gas-phase process can be suitably carried out according to the following steps:
(i) pre-polymerizing with one or more olefins of formula CH₂═CHR, where R is H or a C1-C10 hydrocarbon group, up to forming amounts of polymer from about 0.1 up to about 1000 g per gram of solid catalyst component (a); and
(ii) polymerizing in the gas-phase ethylene, or mixtures thereof with α-olefins CH₂═CHR in which R is a hydrocarbon radical having 1-10 carbon atoms, in one or more fluidized or mechanically stirred bed reactors, in the presence of the product coming from (i).

However, the catalysts of the invention are particularly suited for slurry polymerization in an inert medium such as propane, butane, pentane, hexane, heptane and mixtures thereof.

As already mentioned, the catalysts of the present invention are suitable for preparing ethylene polymers having the desired balance of catalyst activity, hydrogen response and suitable MWD. In particular it is possible to obtain a very narrow molecular weight distribution which is characterized by a F/E ratio of lower than 40, preferably lower than 35 and in some cases lower than 30. When the ethylene is polymerized together with a minor amount of an alpha olefin as comonomer, selected from propylene, butene-1, hexene-1 and octene-1, a linear low density polyethylene having a density lower than 0.940 g/cm³ with a very good quality is obtained which is indicated by the low ratio among weight of xilene soluble fraction and weight of comonomer in the chain. In addition, the catalysts of the invention also show a very good hydrogen response, i.e., the capability of producing low molecular weight polymers in dependence of a given content of molecular weight regulator (usually hydrogen) in the polymerization system. This feature is particularly useful when polymers with a bimodal molecular weight distribution are to be prepared in sequential polymerization steps. In this case, it is suitable to have a catalyst with a good hydrogen response because low molecular weight polymers are produced with a minor amount of Mw regulator and, as a consequence, with a higher activity.

Non limitative examples of other polymers that can be prepared with the catalyst of the invention are very-low-density and ultra-low-density polyethylene (VLDPE and ULDPE, having a density lower than 0.920 g/cm³, to 0.880 g/cm³) consisting of copolymers of ethylene with one or more alpha-olefins having from 3 to 12 carbon atoms, having a mole content of units derived from ethylene of higher than 80%; high density ethylene polymers (HDPE, having a density higher than 0.940 g/cm³), comprising ethylene homopolymers and copolymers of ethylene with alpha-olefins having 3-12 carbon atoms; elastomeric copolymers of ethylene and propylene and elastomeric terpolymers of ethylene and propylene with smaller proportions of a diene having a content by weight of units derived from ethylene of between about 30 and 70% The following examples are given in order to further describe the present invention in a non-limiting manner.

### Characterization

The properties are determined according to the following methods:

Melt Index: measured at 190° C. according to ASTM D-1238 condition “E” (load of 2.16 Kg), “P” (load of 5.0 Kg) and “F” (load of 21.6 Kg);

Fraction soluble in xylene. The solubility in xylene at 25° C. was determined according to the following method: About 2.5 g of polymer and 250 cm³ of o-xylene were placed in a round-bottomed flask provided with cooler and a reflux condenser and kept under nitrogen. The mixture obtained was heated to 135° C. and was kept under stirring for about 60 minutes. The final solution was allowed to cool to 25° C. under continuous stirring, and was then filtered. The filtrate was then evaporated in a nitrogen flow at 140° C. to reach a constant weight. The content of said xylene-soluble fraction is expressed as a percentage of the original 2.5 grams.

### Comonomer Content

1-Butene or α-olefins were determined via Infrared Spectrometry.

Effective density: ASTM-D 1505

Thermal analysis: Calorimetric measurements were performed by using a differential scanning calorimeter DSC Perkin-Elmer. The instrument is calibrated with indium and tin standards. The weighted sample (5-10 mg), obtained from the Melt Index determination, was sealed into aluminum pans, thermostatted at 5° C. for 3 minutes, heated to 200° C. at 20° C./min and kept at that temperature for a time long enough (5 minutes) to allow a complete melting of all the crystallites. Successively, after cooling at 20° C./min to −20° C., the peak temperature was assumed as crystallization temperature (Tc). After standing 5 minutes at 0° C., the sample was heated to 200° C. at a rate of 20° C./min. In this second heating run, the peak temperature was assumed as melting temperature (Tm) and the area as the global melting hentalpy (ΔH).

Determination of Mg, Ti: has been carried out via inductively coupled plasma emission spectroscopy (ICP).

Determination of Cl: has been carried out via potentiometric tritration.

Determination of alkoxides (as ROH): via Gas-Chromatography analysis after hydrolysis of the catalyst.

Solid State NMR analysis. Solid state ¹³C-NMR spectra were recorded on a Bruker DPX-200 spectrometer operating at 50.32 MHz in the Fourier transform mode. Samples were measured at room temperature in a 7 mm ZrO₂ rotor using a spinning speed of 4 KHz. Transients were accumulated using the cross polarization magic angle spinning technique (CP-MAS) with a recycle delay of 5 sec. and a contact time of 1 msec. All NMR experiments employed a proton decoupling field of sufficient magnitude to ensure full decoupling over the entire spectral width.

The rotors were prepared under nitrogen atmosphere.

Crystalline polyethylene in orthorhombic phase was taken as an external reference at 32.85 ppm from tetramethylsilane (TMS).

I_{A} is defined as the integral of the signals having the maximum in the region between 60 and 75 ppm.

I_{B} is defined as the integral of the signals having the maximum in the region between 78 and 108 ppm.

### Ethylene Polymerization: General Procedure.

A 4.5 liter stainless-steel autoclave equipped with a stirrer, temperature and pressure indicator, feeding line for hexane, ethylene, and hydrogen, was used and purified by fluxing pure nitrogen at 70° C. for 60 minutes. Then, 1550 cm³ of hexane containing 4.9 cm³ of 10% by wt/vol TEA/hexane solution, was introduced at a temperature of 30° C. under nitrogen flow. In a separate 200 cm³ round bottom glass bottle were successively introduced, 50 cm³ of anhydrous hexane, 1 cm³ of 10% by wt/vol, TEA/hexane solution and about 0.010÷0.025 g of the solid catalyst of table 1. They were mixed together, aged 10 minutes at room temperature and introduced under nitrogen flow into the reactor. The autoclave was closed, then the temperature was raised to 85° C., hydrogen (partial pressure as indicated in table 2) and ethylene (7.0 bars partial pressure) were added. Under continuous stirring, the total pressure was maintained at 85° C. for 120 minutes by feeding ethylene. At the end the reactor was depressurised and the temperature was dropped to 30° C. The recovered polymer was dried at 70° C. under a nitrogen flow.

### EXAMPLES

All the solvent were deoxygenated, dried over LiAlH₄ and distilled under nitrogen atmosphere before the use.

### TEA is Tris-Ethyl-Aluminum

### TiBA is Tris-isoButyl-Aluminum

### General Preparation of the Precursor

The synthesis of the precursor was performed as described in Example 1 of U.S. Pat. No. 4,220,554. The so obtained support has the following composition:

### Mg, 20.2 wt. %

### Cl, 29.8 wt. %

EtO groups 41.5 wt. %

### Example 1

Into a 500 cm3 four-necked round flask, purged with nitrogen, 280 cm³ of heptane and 17.7 g (147 mg.at. of Mg) of the support previously prepared, were introduced at 25° C. Then, at the same temperature, 17 cm³ (0.154 mol.) of TiCl₄ were added under stirring. The temperature was raised to 50° C. in 1 h and maintained for 2 hours. Then, the stirring was discontinued, the solid product was allowed to settle for 30 minutes and the supernatant liquid was siphoned off.

The solid was washed twice with anhydrous heptane (2×100 cm³) at 50° C. and three times at 25° C. Finally, the solid was dried under vacuum and analyzed. The results are reported in table 1.

### Examples 2-7

The procedure reported in Example 1 was repeated changing the solvent, TiCl₄ amount and temperature/time of treatment as reported in table 1.

### Example 8

15.5 g of the support (129 mg.at. of Mg) were charged, under stirring at 0° C., to a 500 cm³ reactor containing 220 cm³ of pure SiCl₄ and 6.9 cm³ of pure TiCl₄ (62.5 mmol). The temperature was slowly raised to 40° C., then the temperature was kept constant for 4 hours. The stirring was discontinued, settling was allowed to occur and the liquid phase was removed at the temperature of 40° C. The residue was washed with anhydrous heptane, 150 cm³ at 40° C. (twice) then 3 times (150 cm³ each time) with anhydrous heptane at room temperature. The residual solid component was vacuum dried at 50° C. and analyzed. The catalyst characteristics are reported in table 1.

### Examples 9-14

They refer to the polymerization of ethylene carried out according to the general polymerization procedure under the specific conditions and with the catalyst components mentioned in table 2.

### Examples 15-18

### Ethylene/α-Olefin Copolymerization: General Procedure

A 4.5 liter stainless-steel autoclave equipped with a stirrer, temperature, pressure indicator, feeding line for ethylene, propane, 1-butene, hydrogen, and a steel vial for the injection of the catalyst, was purified by fluxing pure nitrogen at 70° C. for 60 minutes. It was then washed with propane, heated to 75° C. and finally loaded with 800 g of propane, 1-butene (the amount reported in table 3), ethylene (7.0 bar, partial pressure) and hydrogen (as in table 3).

In a 100 cm³ three neck glass flask were introduced in the following order, 50 cm³ of anhydrous hexane, the Al-alkyl/hexane solution (as reported in Table 3), optionally the external electron donor compound (table 3) and the solid catalyst 0.005-0.015 g (reported in table 3). They were mixed together and stirred at room temperature for 5 minutes and then introduced in the reactor through the steel vial by using a nitrogen overpressure. Under continuous stirring, the total pressure was maintained constant at 75° C. for 60 minutes by feeding ethylene. At the end the reactor was depressurized and the temperature was dropped to 30° C. The recovered polymer was dried at 70° C. under a nitrogen flow and weighted. The polymer was then characterized as reported in table 3.

### Example 19

Following the procedure of example 1 and under the conditions of example 3, a solid catalyst component was obtained with the following characteristics:

Mg, 15.5 wt. %; Ti, 7.8 wt. %; EtOH, 22.9 wt. % (EtO/Ti=3.1 molar ratio) I_{A}/I_{B} (SS-NMR)=1.34

The solid catalyst was used in the ethylene/1-butene copolymerization in a fluidized gas-phase reactor as described in the following.

A 15.0 liter stainless-steel fluidized reactor equipped with gas-circulation system, cyclone separator, thermal exchanger, temperature and pressure indicator, feeding line for ethylene, propane, 1-butene, hydrogen, and a 1 L steel reactor for the catalyst preactivation (prepolymerization if needed) and injection. The gas-phase apparatus was purified by fluxing pure nitrogen at 40° C. for 12 hours and then was circulated a propane (10 bar, partial pressure) mixture containing 1.5 g of the same Aluminum alkyl used in polymerization, at 80° C. for 30 minutes. It was then depressurized and the reactor washed with pure propane, heated to 75° C. and finally loaded with propane (14.3 bar partial pressure), 1-butene (1.4 bar partial pressure), ethylene (3.8 bar, partial pressure) and hydrogen (0.5 bar, partial pressure).

In a 100 cm3 three neck glass flask were introduced in the following order, 20 cm3 of anhydrous hexane, 8.4 mmol of TiBA as hexane solution and 0.072 g of the solid component upper described. They were mixed together and stirred at room temperature for 5 minutes and then introduced in the preactivation reactor maintained in a propane flow.

The autoclave was closed and 100 g of propane were introduced at 40° C. The mixture was stirred at 50° C. for 30 minutes. The activated catalyst was then injected into the gas-phase reactor by using a propane overpressure (1 bar increase in the gas-phase reactor). The final pressure, in the fluidized reactor, was maintained constant at 80° C. for 120 minutes by feeding a 7 wt. % 1-butene/ethylene mixture.

At the end, the reactor was depressurised and the temperature was dropped to 30° C. The recovered polymer was dried at 70° C. under a nitrogen flow and weighted. 1170 g were achieved providing a mileage of 16.2 kg/gcat with the following characteristics:

MI E, 0.7 dg/min

### MFR (MI F/MI E), 32.3

1-butene content, 7.2 wt. %
Xylene Soluble content, 3.7 wt. %

### Tm, 120.5° C.

TABLE 1

| | Catalyst preparation | | | | Catalyst composition | | | | |
|---|---|---|---|---|---|---|---|---|---|
| | | Ti/Mg | Temp. | time | Mg | Ti | EtOH | EtO/Ti | SS-NMR |
| Ex. | solvent | m · r | ° C. | h | wt. % | wt. % | wt. % | m · r | I_{A}/I_{B} |
| 1 | heptane | 1.0 | 50 | 2 | 14.7 | 8.2 | 22.3 | 3.0 | — |
| 2 | heptane | 0.45 | 70 | 2 | 15.0 | 7.4 | 33.1 | 4.7 | 1.32 |
| 3 | heptane | 0.7 | 70 | 2 | 15.0 | 8.0 | 21.6 | 2.9 | 1.25 |
| 4 | heptane | 2 | 70 | 2 | 15.1 | 8.4 | 15.9 | 2 | 1.21 |
| 5 | heptane | 1 | 90 | 2 | 14.8 | 8.7 | 17.5 | 2.3 | 1.28 |
| 6 | toluene | 0.7 | 40 | 4 | 16.0 | 7.2 | 22.2 | 3.3 | 1.62 |
| 7 | toluene | 7.8 | 40 | 4 | 15.9 | 8.8 | 18.9 | 2.3 | 1.19 |
| 8 | SiCl₄ | 0.5 | 40 | 4 | 16.8 | 4.6 | 25.9 | 6.0 | 2.60 |

TABLE 2

| | | Polymerization conditions | | Polymer Characterization | | | |
|---|---|---|---|---|---|---|---|
| | Solid cat. | H₂ | Polymer | Yield | MI E | | |
| Ex. | component | bar | g | Kg/g_{cat} | g/10′ | MIF/MIP | MIF/MIE |
| 9 | 1 | 4.00 | 630 | 36.8 | 17.8 | — | — |
| 10 | 2 | 3.0 | 480 | 25.7 | 3.60 | 9.9 | 28.9 |
| 11 | 4 | 3.00 | 605 | 27.5 | 14.6 | — | 28.8 |
| 12 | 5 | 4.00 | 580 | 48.3 | 16.5 | 11.4 | 35.2 |
| 13 | 7 | 3.00 | 510 | 26.0 | 11.10 | 10.2 | 31.8 |
| 14 | 8 | 3.00 | 610 | 29.8 | 4.40 | 9.8 | 27.3 |

TABLE 3

| | | Polymerization conditions | | | | | | | | | |
|---|---|---|---|---|---|---|---|---|---|---|---|
| | | | α-olefin | | | | Polymer Characterization | | | | |
| | Solid cat. | Cocatalyst | C₄⁻ | H₂ | time | polymer | Yield | MIE | C₄ | X · S | Tm |
| Ex. | component | type | g | Bar | min | g | Kg/g*h | g/10′ | wt. % | wt. % | ° C. |
| 15 | 3 | TEA (1) | 180 | 1.00 | 61 | 180 | 33.4 | 4.3 | 8.1 | 6.7 | 123.5 |
| 16 | 5 | TEA/DEAC/THF (2) | 150.0 | 1.00 | 21 | 202 | 38.5 | 2.8 | 7.8 | 5.6 | 121.6 |
| 17 | 6 | TEA/DEAC/THF (2) | 180.0 | 1.50 | 88 | 190 | 14.7 | 2.4 | 6.8 | 4.7 | — |
| 18 | 8 | TEA (1) | 180.0 | 0.50 | 120 | 168 | 16.8 | 0.5 | 4.8 | 3.0 | 124.8 |

Polym. Cond (1).: Propane 800 g; TEA, 6.1 mmol; C₂H₄ 7 bar: Temper. 75° C.;.
Polym. Cond. (2): Propane 800 g; TEA, 5.7 mmol; DEAC, 2.7 mmol; THF, 1.7 mmol; C₂H₄ 7 bar; Temper. 75° C.;.

1-10. (canceled)

11. Catalyst components for polymerizing olefins comprising solid catalyst components, the solid catalyst components comprising Ti, Mg, halogen, and OR^{I}, wherein R^{I} is a C₁-C₁₂ hydrocarbon optionally comprising at least one heteroatom, and the solid catalyst components comprising a OR^{I}/Ti molar ratio higher than 1.5, with the proviso that when the OR^{I}/Ti molar ratio is equal to or lower than 3, the solid catalyst components comprise a Mg/Ti molar ratio less than 4, and when the OR^{I}/Ti molar ratio is higher than 4, the solid catalyst components comprise a Mg/Ti molar ratio equal to or higher than 4, and when both the OR^{I}/Ti molar ratio and the solid catalyst components comprise a Mg/Ti molar ratio that ranges from 3 to 4, at least one of the following equations is satisfied:
(Mg/Ti)−(OR^{I}/Ti)≧0.5; 1)
(Mg/Ti)+(OR^{I}/Ti)≧7; 2)
the solid catalyst components further comprising a SS-NMR pattern, the SS-NMR pattern comprising at least one signal (A) comprising a maximum in a region 60-75 (ppm), and at least one signal (B) comprising a maximum in a region 78-108 (ppm), wherein the solid catalyst components comprise a ratio I^{A}/I^{B} higher than 0.8, wherein I^{A} is an integral of the at least one signal comprising a maximum in a region between 60 and 75 (ppm); and I^{B} is an integral of the at least one signal comprising a maximum in a region between 78 and 108 (ppm).

12. The catalyst components according to claim 11, wherein the ratio I^{A}/I^{B} is higher than 1.

13. The catalyst components according to claim 11, wherein R^{I} is a C₁-C₈ hydrocarbon selected from alkyl groups.

14. The catalyst components according to claim 11, wherein the amount of titanium is higher than 4%, with respect to a total weight of the solid catalyst component.

15. The catalyst components according to claim 11, wherein the OR^{I}/Ti molar ratio is higher than 2.

16. Catalyst components for polymerizing olefins comprising solid catalyst components, the solid catalyst components comprising Ti, Mg, halogen, and OR^{I}, wherein R^{I} is a C₁-C₁₂ hydrocarbon optionally comprising at least one heteroatom, and the solid catalyst components comprising a OR^{I}/Ti molar ratio higher than 1.5, with the proviso that when the OR^{I}/Ti molar ratio is equal to or lower than 3, the solid catalyst components comprise a Mg/Ti molar ratio less than 4, and when the OR^{I}/Ti molar ratio is higher than 4, the solid catalyst components comprise a Mg/Ti molar ratio equal to or higher than 4, and when both the OR^{I}/Ti molar ratio and the solid catalyst components comprise a Mg/Ti molar ratio that range from 3 to 4, at least one of the following equations is satisfied:
(Mg/Ti)−(OR^{I}/Ti)≧0.5; 1)
(Mg/Ti)+(OR^{I}/Ti)≧7; 2)
the solid catalyst components obtained by reacting a titanium compound comprising at least one Ti—Cl bond with a catalyst precursor of formula MgClₙ(OR^{I})₂₋ₙ, wherein n is from 0.5 to 1.5; and R^{I} is a C₁-C₁₂ hydrocarbon optionally comprising at least one heteroatom.

17. The catalyst components according to claim 16, wherein the titanium compound comprises formula Ti(OR^{I})_{p-y}Cl_{y}, wherein R^{I} is a C₁-C₁₂ hydrocarbon optionally comprising at least one heteroatom; p is a titanium valence; and y is a number between 1 and p.

18. The catalyst components according to claim 16 obtained by reacting the catalyst precursor with the titanium compound in an amount such that a molar ratio between the titanium compound and the OR^{I}, of the catalyst precursor is less than 4.

19. The catalyst components according to claim 16, wherein the catalyst components are obtained in a reaction carried out in an inert medium, wherein the inert medium is liquid at least at reaction temperature.

20. A catalyst for polymerizing olefins CH₂═CHR, wherein R is hydrogen or a C₁-C₁₂ hydrocarbyl, the catalyst comprising a product of a reaction between:
(a) a catalyst component comprising solid catalyst components, the solid catalyst components comprising Ti, Mg, halogen, and OR^{I}, wherein R^{I} is a C₁-C₁₂ hydrocarbon optionally comprising at least one heteroatom, and the solid catalyst components comprising a OR^{I}/Ti molar ratio higher than 1.5, with the proviso that when the OR^{I}/Ti molar ratio is equal to or lower than 3, the solid catalyst components comprise a Mg/Ti molar ratio less than 4, and when the OR^{I}/Ti molar ratio is higher than 4, the solid catalyst components comprise a Mg/Ti molar ratio equal to or higher than 4, and when both the OR^{I}/Ti molar ratio and the solid catalyst components comprise a Mg/Ti molar ratio that ranges from 3 to 4, at least one of the following equations is satisfied:
(Mg/Ti)−(OR^{I}/Ti)≧0.5; 1)
(Mg/Ti)+(OR^{I}/Ti)≧7; 2)
the solid catalyst components further comprising a SS-NMR pattern, the SS-NMR pattern comprising at least one signal (A) comprising a maximum in a region 60-75 (ppm), and at least one signal (B) comprising a maximum in a region 78-108 (ppm), wherein the solid catalyst components comprise a ratio I^{A}/I^{B} higher than 0.8, wherein I^{A} is an integral of the at least one signal comprising a maximum in a region between 60 and 75 (ppm); and I^{B} is an integral of the at least one signal comprising a maximum in a region between 78 and 108 (ppm),
(b) an alkylaluminum compound; and
(c) optionally, an external electron donor compound.
